(19) United States
(12) Patent Application Publication
(10) Pub. No.: US 2022/0110299 A1
(43) Pub. Date: Apr. 14, 2022

(54) Brooder Assembly

(71) Applicant: Randall Eaglen, Morgantown, WV (US)

(72) Inventor: Randall Eaglen, Morgantown, WV (US)

(21) Appl. No.: 17/065,757

(22) Filed: Oct. 8, 2020

(51) Int. Cl. A01K 31/14; A01K 45/00

(52) U.S. Cl. CPC A01K 31/14; A01K 45/00

(57) ABSTRACT

A brooder assembly for warming chicks in a simulated natural environment includes a pad, which is heated and thus can heat chicks positioned on a top of the pad. A figurine is engaged to and extends from the top of the pad. The figurine is substantially centrally positioned on the pad. The figurine is shaped to mimic a hen standing upon the pad and thus can comfort the chicks positioned on the pad. The figurine also reflects heat emanating from the pad downwardly upon the chicks.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to brooder assemblies and more particularly pertains to a new brooder assembly for warming chicks in a simulated natural environment.

### (2) Description of Related Art Including Information Disclosed Under 37 CFR 1.97 and 1.98

The prior art relates to brooder assemblies, which may comprise heating lamps or heating pads configured to be positionable above chicks. What is lacking in the prior art is a brooder assembly that warms chicks in a simulated natural environment including a simulated mother hen and a simulated nest.

### BRIEF SUMMARY OF THE INVENTION

An embodiment of the disclosure meets the needs presented above by generally comprising a pad, which is heated and thus configured to heat chicks positioned on a top of the pad. A figurine is engaged to and extends from the top of the pad. The figurine is substantially centrally positioned on the pad. The figurine is shaped to mimic a hen standing upon the pad and thus is configured to comfort the chicks positioned on the pad. The figurine also is configured to reflect heat emanating from the pad downwardly upon the chicks.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a brooder assembly according to an embodiment of the disclosure.

FIG. 2 is a bottom view of an embodiment of the disclosure.

FIG. 3 is a cross-sectional view of an embodiment of the disclosure.

FIG. 4 is an in-use view of an embodiment of the disclosure.

### DETAILED DESCRIPTION OF THE INVENTION

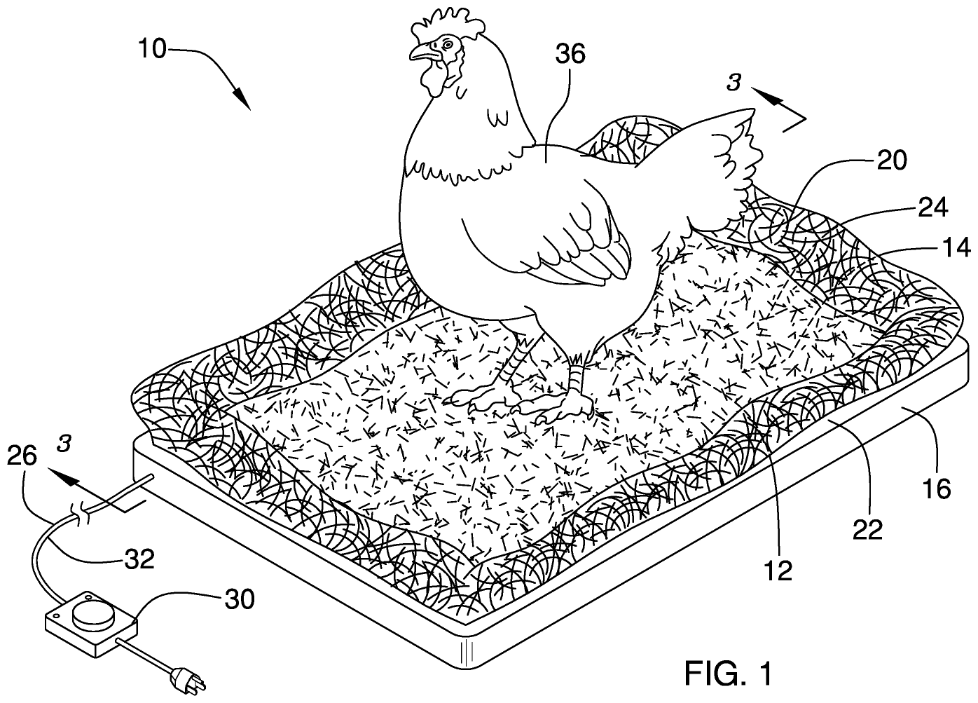

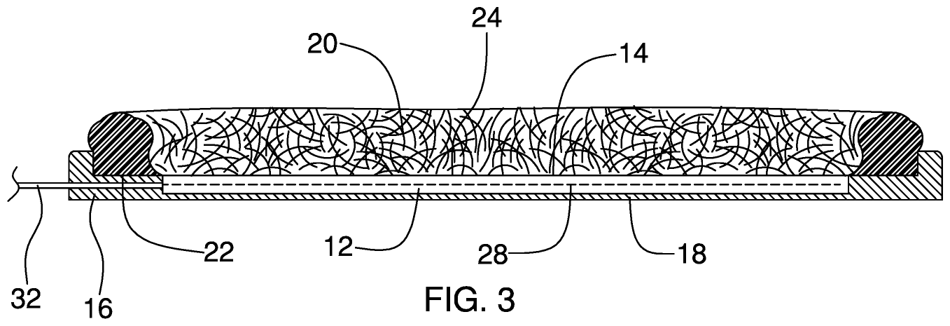

With reference now to the drawings, and in particular to FIGS. 1 through 4 thereof, a new brooder assembly embodying the principles and concepts of an embodiment of the disclosure and generally designated by the reference numeral 10 will be described.

As best illustrated in FIGS. 1 through 4, the brooder assembly 10 generally comprises a pad 12, which is heated and thus configured to heat chicks positioned on a top 14 of the pad 12. A base 16 is engaged to a bottom 18 of the pad 12. The base 16 is circumferentially larger than the pad 12. A protrusion 20 is engaged to and extends upwardly from a perimeter 22 of the base 16 and extends circumferentially around the pad 12. A panel 24 is engaged the top 14 of the pad 12 and to the protrusion 20 so that the panel 24 covers the top 14 of the pad 12. The protrusion 20 and the panel 24 are molded so that the protrusion 20 and the panel 24 mimic a chicken nest.

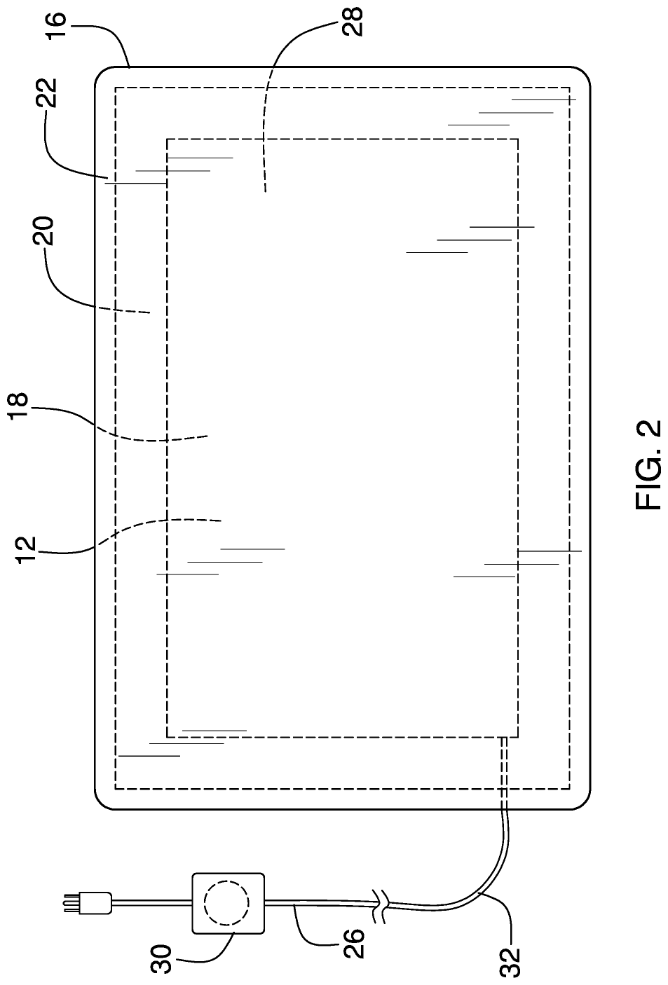

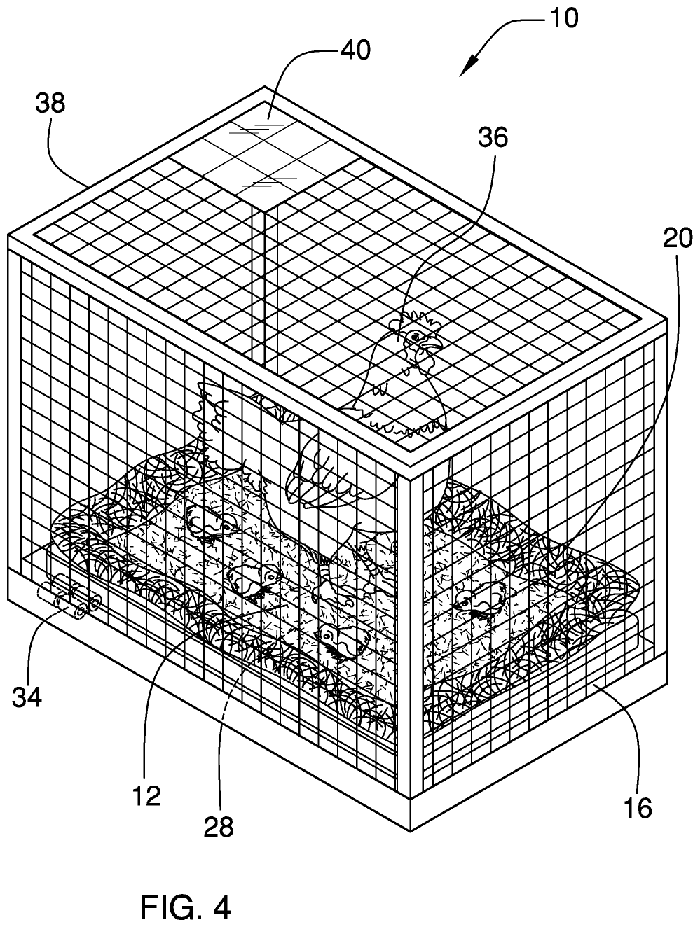

The assembly 10 also comprises a power module 26, a heating element 28, and a thermostat 30. The power module 26 comprises a power cord 32, as shown in FIG. 2, or a battery 34, as shown in FIG. 4. The heating element 28 is positioned in the pad 12 and is operationally engaged to the power module 26. The thermostat 30 is operationally engaged to the power module 26 and the heating element 28 and thus is positioned to regulate heat output by the heating element 28.

A figurine 36 is engaged to and extends from the top 14 of the pad 12. The figurine 36 is engaged to the panel 24 and is substantially centrally positioned on the pad 12. The figurine 36 is shaped to mimic a hen standing upon the pad 12 and thus is configured to comfort the chicks positioned on the pad 12. The figurine 36 also is configured to reflect heat emanating from the pad 12 downwardly upon the chicks.

The figurine 36, the base 16, the protrusion 20, and the panel 24 comprise plastic. The pad 12 is sealably enclosed between the base 16 and the panel 24. The figurine 36, the base 16, the protrusion 20, and the panel 24 are configured to be washed.

The assembly 10 also may comprise a cage 38, which is opened bottomed. The cage 38 is selectively positionable over the figurine 36 and the pad 12. The cage 38 thus is configured to retain the chicks therein.

In one embodiment wherein the power module 26 comprises a battery 34, as shown in FIG. 4, the battery 34 is rechargeable. A solar panel 40 is engaged to the cage 38 and is operationally engaged to the battery 34. The solar panel 40 is configured to convert electromagnetic radiation into an electrical current to charge the battery 34.

In one example of use, the assembly 10 is positioned in an area where chicks are to be kept. The power cord 32 is plugged into an outlet and the thermostat 30 is used to set a temperature appropriate for warming the chicks. The chicks are free to access the assembly 10 to be warmed by the pad 12 and comforted by the figurine 36, but also can roam freely about the area.

In another example of use wherein the assembly 10 comprises a cage 38, the cage 38 is positionable over the figurine 36 and the pad 12 to retain the chicks within the cage 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A brooder assembly comprising:
a pad;
a heating element positioned in the pad such that the pad is heated, wherein the pad is configured for heating chicks positioned on a top thereof; and
a figurine engaged to and extending from the top of the pad, the figurine being shaped to mimic a hen standing upon the pad, the figurine being substantially centrally positioned on the pad, wherein the figurine is configured for comforting the chicks positioned on the pad and for reflecting heat emanating from the pad downwardly upon the chicks.

2. The brooder assembly of claim 1, further including:
a base engaged to a bottom of the pad, the base being circumferentially larger than the pad;
a protrusion engaged to and extending upwardly from a perimeter of the base, the protrusion extending circumferentially around the pad; and
a panel engaged the top of the pad and to the protrusion, such that the panel covers the top of the pad, the protrusion and the panel being molded such that the protrusion and the panel mimic a chicken nest.

3. The brooder assembly of claim 1, further including:
a power module, the power module comprising a power cord or a battery;
the heating element being operationally engaged to the power module; and
a thermostat operationally engaged to the power module and the heating element, such that the thermostat is positioned for regulating heat output by the heating element.

4. The brooder assembly of claim 2, wherein:
the figurine is engaged to the panel; and
the figurine, the base, the protrusion, and the panel comprise plastic, such that the pad is sealably enclosed between the base and the panel, wherein the figurine, the base, the protrusion, and the panel are configured for being washed.

5. The brooder assembly of claim 1, further including a cage, the cage being opened bottomed such that the cage is selectively positionable over the figurine and the pad, wherein the cage is configured for retaining the chicks therein.

6. The brooder assembly of claim 3, further including:
a cage, the cage being opened bottomed such that the cage is selectively positionable over the figurine and the pad, wherein the cage is configured for retaining the chicks therein;
the power module comprising a battery, the battery being rechargeable; and
a solar panel engaged to the cage and operationally engaged to the battery, wherein the solar panel is configured for converting electromagnetic radiation into an electrical current for charging the battery.

7. A brooder assembly comprising:
a pad, the pad being heated, wherein the pad is configured for heating chicks positioned on a top thereof;
a base engaged to a bottom of the pad, the base being circumferentially larger than the pad;
a protrusion engaged to and extending upwardly from a perimeter of the base, the protrusion extending circumferentially around the pad;
a panel engaged the top of the pad and to the protrusion, such that the panel covers the top of the pad, the protrusion and the panel being molded such that the protrusion and the panel mimic a chicken nest, the base, the protrusion, and the panel comprising plastic, such that the pad is sealably enclosed between the base and the panel, wherein the base, the protrusion, and the panel are configured for being washed;
a power module, the power module comprising a power cord or a battery, the battery being rechargeable;
a heating element positioned in the pad and operationally engaged to the power module;
a thermostat operationally engaged to the power module and the heating element, such that the thermostat is positioned for regulating heat output by the heating element;
a figurine engaged to and extending from the top of the pad, the figurine being shaped to mimic a hen standing upon the pad, the figurine being substantially centrally positioned on the pad, wherein the figurine is configured for comforting the chicks positioned on the pad and for reflecting heat emanating from the pad downwardly upon the chicks, the figurine being engaged to the panel, the figurine comprising plastic, wherein the figurine is configured for being washed;
a cage, the cage being opened bottomed such that the cage is selectively positionable over the figurine and the pad, wherein the cage is configured for retaining the chicks therein; and
a solar panel engaged to the cage and operationally engaged to the battery, wherein the solar panel is configured for converting electromagnetic radiation into an electrical current for charging the battery.
